(19) United States
(12) Patent Application Publication
(10) Pub. No.: US 2024/0199327 A1
(43) Pub. Date: Jun. 20, 2024

(54) SHUTTLE SYSTEM AND METHOD FOR HANDLING A LOAD CARRIER

(71) Applicant: Gebhardt Fördertechnik GmbH, Sinsheim (DE)

(72) Inventors: Marco Gebhardt, Sinsheim (DE); Thomas Klopfenstein, Wimmenau (FR)

(21) Appl. No.: 18/373,522

(22) Filed: Sep. 27, 2023

(30) Foreign Application Priority Data
Sep. 27, 2022 (DE) 10 2022 124 753.8

(51) Int. Cl. B65G 1/04; B65G 1/06; B65G 1/137

(52) U.S. Cl. CPC B65G 1/0492; B65G 1/065; B65G 1/1376

(57) ABSTRACT

A method is disclosed for handling a load carrier that can be stored or removed from a rack structure. In an embodiment the method includes temporary storage of the load carrier in a buffer area, which may also serve as a transfer area to a vertical conveyor, or passing through the buffer area to transport the load carrier in a storage and retrieval area level to be moved in or out.

### CROSS-REFERENCE TO RELATED APPLICATION

This application claims priority to German Patent Application No. 10 2022 124 753.8, filed Sep. 27, 2022, the contents of which is hereby incorporated by reference in its entirety.

### TECHNICAL FIELD

The invention relates to a shuttle system and a method for handling a load carrier according to the independent claims.

### BACKGROUND

Generic shuttle systems and methods are known from the prior art.

### SUMMARY

The object of the present invention is to overcome the disadvantages of the prior art.

The subject matters of the independent claims lead to the solution of the object. Advantageous embodiments are described in the dependent claims.

A shuttle system according to a preferred embodiment of the present invention comprises a rack structure with a storage and retrieval level and at least one warehouse for storing load carriers. The rack structure may comprise exactly one storage and retrieval level. It may also be contemplated that the rack structure comprises multiple storage and retrieval levels.

In the context of the present invention, “levels”, in particular the “storage and retrieval levels” as well as the “warehouse levels” are components of the rack structure. The term “level” is therefore preferably not to be understood generally as “being at the same height level”, but in the sense of a “floor” of the rack structure.

The load carriers can be, for example, large load carriers. They can be pallets, wire mesh boxes, sheet metal pallets, so-called “intermediate bulk containers” (IBC containers) or the like. The load carriers may contain loads, i.e. goods, articles or the like.

The storage and retrieval level can also contain storage locations. The storage and retrieval level is therefore not limited to the functions of storage and retrieval, but can also be used for storing load carriers. This can be advantageous because when storing a load carrier in the storage and retrieval level, the vertical conveyor described below is not required, which means that storage can be performed more quickly. The same applies to retrieval from the storage and retrieval level.

Usually, the storage and retrieval level is the lowest level in the rack structure of a shuttle system. However, it is also possible to have a rack structure in which the storage and retrieval level is not the lowest level. For example, for reasons of space, several warehouse levels can be laid out underground, as a “basement”, so to speak. Furthermore, it can be considered to place the storage and retrieval level centrally in relation to a height of the rack structure in order to shorten an average travel time of vertical conveyors still described below.

The shuttle system further comprises a vertical conveyor for transporting load carriers between the levels of the rack structure, as well as at least one shuttle which is arranged to travel in the levels of the rack structure. The vertical conveyor is preferably assigned to the rack structure. Particularly preferably, the vertical conveyor is situated within the rack structure.

Preferably, the vertical conveyor connects and serves all levels of the rack structure, also called rack levels. However, it is also possible to think of embodiments, especially with several vertical conveyors, in which each vertical conveyor connects and serves only some, but not all, of the rack levels. Preferably, however, each vertical conveyor connects and serves at least the storage and retrieval levels as well as several warehouse levels.

Preferably, the shuttles are level-bound shuttles that can move along the levels of the rack structure in the entire horizontal direction, but not vertically. However, aisle-bound shuttles, which can only move along a straight line, may also be considered.

Preferably, at least one shuttle is situated on each level of the rack structure.

The shuttle system further comprises at least one buffer location, which is situated in the storage and retrieval level directly next to the vertical conveyor, wherein the at least one buffer location is arranged to temporarily receive a load carrier, wherein the at least one buffer location for receiving and delivering the load carrier comprises a transfer section on the storage side, on the pre-zone side and on the vertical conveyor side. The at least one buffer location is preferably an active buffer location, which can be for example formed by a chain conveyor arrangement described below or by a single chain conveyor.

The transfer sections could also be referred to as entrances to the buffer location.

The transfer sections can also be distributed among several corresponding buffer locations of the storage and retrieval level, for example in connection with each other via the same vertical conveyor. Each individual buffer location therefore does not have to comprise all transfer sections.

In the context of the present invention, only the buffer locations situated immediately adjacent to the vertical conveyor are usually referred to simply as the “buffer location”. The buffer locations not situated directly next to the vertical conveyor are usually referred to as “further buffer location”.

Each buffer location and each further buffer location can be formed by one chain conveyor each. Such chain conveyors connected in series can form the chain conveyor arrangement. The load carrier can be passed from one chain conveyor to the next in the chain conveyor arrangement. Preferably, each chain conveyor within the chain conveyor arrangement comprises its own actuator so that each of the chain conveyors can be operated independently of the other chain conveyors.

However, in the context of the present invention, it may also be contemplated that each buffer location is not formed by a separate chain conveyor, but that a single chain conveyor provides several or all of the buffer locations. For example, if a chain conveyor forms two buffer locations, these two buffer locations are not physically separated from each other, but are merely present as sections or areas of the chain conveyor forming them.

In general, therefore, it should be noted that a chain conveyor arrangement includes at least one chain conveyor that forms or provides at least one buffer location.

The shuttle is also set up to transfer a load carrier to be retrieved to the buffer location and to take over a load carrier to be stored from the buffer location, wherein this takeover and transfer is performed via the transfer section on the storage side.

The takeover and transfer described above can be performed directly or indirectly, i.e. for example via another buffer location.

The buffer location is also set up to take over a load carrier from or transfer it to a conveyor, wherein this conveyor acts as an interface between the storage and retrieval level and a zone located outside the rack levels, and wherein this takeover and transfer is performed via the transfer section on the pre-zone side. The aforementioned rack levels preferably mean the storage and retrieval levels as well as the warehouse levels. For simplicity, the pre-zone side transfer section is also referred to as such in embodiments without a storage pre-zone.

The zone located outside the rack levels can be designed in numerous variants depending on the construction of the rack structure and the selection of the conveyor acting as an interface.

As will be described in more detail below, the conveyor acting as an interface may travel or be situated entirely or partially within the zone located outside the rack levels.

For example, it can be thought of assigning a storage pre-zone to the rack level, which is known from the prior art. In this case, the storage and retrieval level can be situated, for example, at or near the floor level of, for example, a hall floor or the like, usually at floor level or just above. In such an embodiment, the conveyor acting as an interface is preferably set up to transfer the load carrier to the buffer location or the further buffer location in the storage and retrieval level or to take it over from there without using any auxiliary means. An automated guided vehicle system (AGV) can, for example, comprise a lifting device for the load carrier in order to overcome certain small height differences to the buffer location or the further buffer location. A chain conveyor or the like can be situated and aligned in such a way that direct transfer or takeover to or from the (further) buffer location is possible without auxiliary means.

When an AGV is referred to in the context of the present invention, this preferably refers to the driverless vehicles that are also sometimes referred to as automated guided vehicles (AGVs) in the prior art.

It may also be considered that the rack levels of the rack structure overbuild the aforementioned zone located outside the rack levels or are otherwise situated well above this zone. In such cases, auxiliary means may be intended to overcome the height difference between the conveyor acting as an interface and the (further) buffer location when taking over or transferring the load carrier from and to the (further) buffer location. Such an auxiliary means may be, for example, a vertical conveyor for the load carrier or the AGV. It can also be considered that the conveyor acting as interface, for example an AGV, overcomes the height difference itself by means of, for example, a built-in lifting device, so that auxiliary means can be dispensed with.

The conveyor acting as an interface can generally be any conveyor situated or traveling in the zone outside the rack levels. The aforementioned conveyor may be a continuous conveyor or a discontinuous conveyor. In particular, as already indicated several times, AGVs or chain conveyors can be thought of herein.

An AGV acting as an interface can interact with the storage and retrieval level in various ways to transfer or take over a load carrier, depending on the arrangement and design of the rack structure.

If a pre-storage zone is available, the AGV can travel exclusively or predominantly there. It is also conceivable that the AGV travels a short distance into the rack structure for the purpose of transferring and accepting goods from and to the buffer location. Such an AGV can therefore also travel within the rack structure, in particular by driving a short distance into it as described. For example, it can be considered that the AGV enters the chain conveyor that forms the buffer location or the further buffer location.

If a zone in which the AGV travels is covered by the rack levels, the AGV can travel partially or completely over an area located below the rack levels. Thus, an area outside the floor plan of the rack structure, which the AGVs need for their driveways, can be at least significantly smaller than in other variants. Vertical conveyors can be considered here, which take over the load carrier from the AGV and transfer it to the (further) buffer location, or which transport the AGV vertically to the (further) buffer location. Alternatively, it can be considered that the AGV has a lifting device which can transport the load carrier to the height of the buffer location while the AGV is on its driveway, for example below the storage and retrieval level. The vertical conveyor described above, which takes over the load carrier from the AGV and transfers it to the buffer location or to the further buffer location, is preferably not the vertical conveyor described above, which is used to transport load carriers between the levels of the rack structure.

The vertical conveyor described above can also be the conveyor acting as the interface. Alternatively, such a vertical conveyor may form this interface together with, for example, the AGV. It may therefore be envisaged that each existing interface is formed by a single conveyor or that each existing interface is formed by a combination comprising two or even more than two conveyors.

A chain conveyor acting as an interface may likewise be situated, for example, in a pre-storage zone or another zone located outside the floor plan of the rack structure. Alternatively, such a chain conveyor may be situated below, for example, the storage and retrieval level if the rack levels are directly above its location. Such a chain conveyor can also act as an interface if it is located at least partially or at least predominantly within the rack structure. Just as mentioned above with regard to the AGV, such a chain conveyor can also function jointly as an interface together with a vertical conveyor, which overcomes a height difference between the location of the chain conveyor and the storage and retrieval level.

In general, the conveyor acting as an interface is preferably an active conveyor, which is equipped with an actuator, for example, and is set up to actively convey the load carrier.

The transfer to and from the buffer location described above in relation to the conveyor acting as an interface can be performed directly or indirectly.

For simplicity, when referring to “an AGV” or “a chain conveyor” or generally “a conveyor acting as an interface”, it is nevertheless preferably contemplated that the shuttle system comprises a plurality of such AGVs or chain conveyors acting as an interface. In some embodiments, it may also be contemplated that the shuttle system comprises a variety of interfacing conveyors, i.e. for example both AGVs and chain conveyors.

The conveyor acting as an interface may be located substantially or partially outside the rack structure. If this conveyor is a chain conveyor or similar continuous conveyor, it can also be surrounded by components of the rack structure, for example to generate additional storage locations. The conveyor acting as an interface can herein be completely surrounded by components of the rack structure in such a way that it is located completely within the rack structure, but still acts as an interface, for example to the pre-storage zone. Such a conveyor located inside the rack structure can act as an interface together with another conveyor.

Assigned to the vertical conveyor is a means which can actively transfer or take over the load carrier from the buffer location to the vertical conveyor, wherein this take over and transfer is performed via the vertical conveyor-side transfer section. Here, “assigned” means that the vertical conveyor can comprise the means described above, or it is a separate means which is situated in such a way that it can accomplish the takeover and transfer described above. This separate means may, for example, be attached to any structure in the rack structure. If the vertical conveyor includes an active means of transfer, for example a telescopic fork described in more detail below, the advantage is that only the vertical conveyor needs to include this means. For example, if a structure on the rack structure is intended to provide for the transfer and takeover of load carriers to and from the vertical conveyor, a corresponding structure would have to be intended on each level of the rack structure. Such an embodiment is nevertheless conceivable and encompassed by the present invention. Such a structure may be rams which can push the load carrier, or other suitable devices.

A direction along which the buffer location transfers the load carrier to or takes it over from the conveyor acting as an interface can run parallel to a direction along which the shuttle transfers the load carrier to or takes it over from the buffer location. If there are several buffer locations, in particular two, situated directly next to the vertical conveyor, the above comments preferably apply to both buffer locations.

A direction along which the vertical conveyor transfers the load carrier to the buffer location or takes it over from the latter runs orthogonally to the direction along which the conveyor acting as interface and preferably the shuttle transfer the load carrier to the buffer location or take it over from the latter. If there is one buffer location and several further buffer locations, which are formed by a chain conveyor arrangement or the like, as will be explained below, a transfer direction between the vertical conveyor and the buffer location therefore runs orthogonally to a longitudinal direction of the chain conveyor arrangement or the like.

The shuttle system described above offers the advantage of decoupling a material flow during storage and retrieval from the vehicles or other conveyors used for this purpose within the rack structure and, for example, in the pre-storage zone, to the extent that the respective vehicle does not have to wait or stand by for a transfer of a load carrier to and from one of the vehicles or to and from the vertical conveyor thanks to the at least one buffer location.

Another advantage of a vertical conveyor situated next to the buffer location(s) is that the vertical conveyor does not “get in the way” of a load carrier to be retrieved at the storage and retrieval level. If the buffer location and, if applicable, the further buffer locations are placed by the same chain conveyor arrangement, the vertical conveyor therefore does not “interrupt” a conveyor section produced by the chain conveyor arrangement. A load carrier coming from the pre-storage zone can be retrieved to the storage and retrieval level without interaction with the vertical conveyor.

Theoretically, it would be conceivable to build the vertical conveyor in series with the at least one buffer location. The transfer direction between the vertical conveyor and the buffer location could herein run parallel to the longitudinal direction of the chain conveyor arrangement or coincide with it. However, since such an arrangement of the vertical conveyor would “interrupt” the chain conveyor arrangement in the storage and retrieval level, and a load carrier to be placed in the storage and retrieval level would always have to pass the vertical conveyor and, if necessary, wait for it if it is currently located in a higher warehouse level, this variant is not preferred in the context of the present invention.

If the vertical conveyor is situated next to the chain conveyor arrangement or the like, which forms a buffer location and, if necessary, further buffer locations, a further advantage is that the shuttle can enter the chain conveyor arrangement or the like, preferably an end chain conveyor of this chain conveyor arrangement, for transfer and takeover of the load carrier.

The shuttle system can include a further buffer location between the pre-zone side transfer section and the conveyor acting as an interface. This further buffer location is therefore preferably between the pre-zone side transfer section and the pre-storage zone. Preferably, one or more such further buffer locations are directly adjacent to the pre-zone-side transfer section. These additional buffer locations offer the advantage that the buffer location served by the vertical conveyor is only occupied for a very short time in each case, because a load carrier to be removed from storage can be conveyed directly to one of the additional buffer locations after being deposited at the buffer location.

In the context of the present invention, the conveyor acting as an interface can optionally be understood as part of the shuttle system, but this is not mandatory.

The vertical conveyor can include the means already described above, which can actively transport the load carrier from the buffer location to the vertical conveyor and back. This may be a telescopic fork. Alternatively, it may be thought of assigning a corner transfer unit to the buffer location or equipping the buffer location with such a corner transfer unit. The corner transfer unit can form the buffer location and in this respect be used as an alternative to a chain conveyor forming the buffer location. The corner transfer unit preferably allows a load carrier to be transported both along the transfer direction, i.e. to the vertical conveyor and along the longitudinal direction.

Exactly two directly adjacent buffer locations can be assigned to the vertical conveyor. These can allow double play and thus avoid empty runs of the vertical conveyor.

The shuttle system can include at least one further buffer location, which adjoins the storage-side transfer section.

The buffer location and the further buffer locations may be situated along a straight line. The aforementioned buffer locations can be formed by a continuous conveyor, for example a chain conveyor. This chain conveyor can be some of the chain conveyor arrangement already described.

The shuttle system may comprise a centering means which is arranged to center the load carrier after it has been delivered by the conveyor acting as interface and before it has been taken over by the shuttle or by the vertical conveyor. Alternatively or additionally, it can also be thought of that a centering takes place by an interaction of the shuttle and the centering means, which is described in more detail with respect to the figures. The centering means can eliminate misplacements, for example any twisting or shifting of the load carrier relative to a desired position. In particular, the shuttle is sensitive to incorrectly positioned, i.e. not centered, load carriers, which can lead to errors and malfunctions in the rack structure, which is usually difficult to access. The aforementioned centering means is preferably located at the buffer location.

The additional buffer location, from which the shuttle in the storage and retrieval level can take over the load carrier that has previously passed through the buffer location, can also include at least one centering means.

The shuttle system can include a transfer section, which is preferably located on the warehouse level. This transfer section can be set up to temporarily take over a load carrier. The transfer section can further comprise at least one centering means, which is arranged to center a load carrier when it is placed on the transfer section by the shuttle or the vertical conveyor.

The transfer section can comprise two parking rails for parking the load carrier, wherein a centering means can be situated on each of these parking rails, wherein a clear width between the centering means can correspond at least to the clear width between the parking rails.

The centering means can be of any shape. In general, the centering means may be thought of as comprising inclined surfaces along which the load carrier can slide for centering when it is lowered. The centering means may comprise inclined surfaces sloping toward the center of the buffer location or transfer section at which they are situated. As already described in the context of the present invention, centering means may also be contemplated which effect centering by, for example, driving a load carrier located on a chain conveyor against the centering means and, if necessary, rotating, for example, to correct misplacement in the sense of rotation. Such centering means may be designed as vertical surfaces, which therefore do not slope inclinedly towards the center of the buffer location or transfer section concerned. The centering means can, for example, be designed to be foldable, pivotable or retractable. After centering, the centering means can, for example, be folded away or recessed to allow further transport of the load carrier, in particular by the chain conveyor arrangement.

The aforementioned folding, pivoting, retractable or otherwise movable centering means can be situated within the transfer section on the storage side or in the immediate vicinity thereof.

According to one embodiment, only the storage and retrieval levels may comprise active buffer locations that can effect transport of load carriers deposited there. In this embodiment, the warehouse levels comprise passive buffer locations, for example in the form of parking rails, which can only temporarily take over a load carrier but cannot move it. In this embodiment, the shuttles are level-bound and can therefore move horizontally in the level in which they are located, but cannot leave this level independently, i.e. without being transported by a vertical conveyor, for example.

With regard to the parking rails, it should be mentioned that all driveways or a predominant part of the driveways of the rack structure may comprise parking rails and shuttle tracks situated below them.

The shuttle system may include several of the arrangements described above, each comprising a vertical conveyor and at least one immediately adjacent buffer location in the storage and retrieval level. Preferably, the storage and retrieval level comprise at least one buffer location for retrieval and at least one buffer location for storage of load carriers. If a vertical conveyor serves two buffer locations, one of the buffer locations is preferably used for retrieval and the other for storage. The vertical conveyor can perform a double play in this case.

Alternatively, exactly one vertical conveyor can be assigned to the or each buffer location. In such a constellation, the vertical conveyors usually perform individual plays.

The buffer location immediately adjacent to the vertical conveyor, usually referred to simply as the “buffer location” above, can also be referred to as the transfer or takeover location for the vertical conveyor.

This buffer location can also connect the conveyor, which acts as an interface, to the vertical conveyor and the shuttles running in the rack levels.

The shuttle system can include several vertical conveyors in the rack structure. If the areas of the levels, i.e. the storage and retrieval levels and the storage locations are large and comprise a correspondingly large number of storage locations, it can make sense to use a large number of vertical conveyors. These can be situated at a certain distance from each other. Alternatively, it may be considered to provide several vertical conveyors situated directly next to each other. In this case, several directly adjacent buffer locations, which also function as transfer sections, can be intended.

The present invention also includes, in addition to the embodiments of the shuttle system described above, the method described below. Features and details described above with respect to the shuttle system also apply to the method described below, and vice versa.

A method for handling a load carrier, wherein storage or retrieval of the load carrier to or from of a rack structure is to be effected, may comprise the following step:
temporarily storing the load carrier at a buffer location, which also serves as a transfer section to a vertical conveyor, or passing through said buffer location to retrieve or store the load carrier into or out of a storage and retrieval level.

The temporary storage of the load carrier at the buffer location can extend over only a very short time interval and could therefore also be referred to as an “intermediate stop”. Nevertheless, the context of the method refers to a storing.

The rack structure can be part of a shuttle system already described above and can include at least one storage and retrieval level as well as warehouse levels in which shuttles operate.

In the context of the method the load carrier can be stored in the rack structure, whereby the following steps are carried out:
a conveyor conveys the load carrier to the storage and retrieval level, where the load carrier is conveyed to the buffer location,
if the load carrier is to be stored in the storage and retrieval level, it passes the buffer location and is taken over by a shuttle running in the storage and retrieval level,
if the load carrier is to be stored in a warehouse level, it is taken over at the buffer location by the vertical conveyor and transported to the warehouse level.

The aforementioned transport of the load carrier into the storage and retrieval level preferably means that the load carrier is brought, for example, from a pre-storage zone into the storage and retrieval level of the rack structure. This storage and retrieval level preferably means the corresponding floor of the rack structure. It is therefore preferably irrelevant from which level the load carrier is conveyed on the conveyor to the storage and retrieval level. Conveying the load carrier to the storage and retrieval level therefore does not necessarily involve a vertical movement of the load carrier.

The load carrier can be conveyed directly or indirectly via a chain conveyor arrangement or the like, which forms the buffer location and possibly further buffer locations, to the buffer location.

The warehouse level, preferably a plurality of warehouse levels, is or are usually situated above the storage and retrieval level. However, it may be thought of placing at least one or some of the warehouse levels below the storage and retrieval level.

In the context of the method, the load carrier may be retrieved from the rack structure, whereby the following steps are carried out:
the shuttle or the vertical conveyor transports the load carrier to the buffer location,
a conveyor takes over the load carrier.

The shuttle can transport the load carrier directly to the buffer location. Preferably, the shuttle transports the load carrier indirectly to the buffer location by first transferring it to another buffer location from which the load carrier reaches the buffer location. This preferably applies to shuttles operating in the storage and retrieval level. A shuttle operating in one of the warehouse levels can transport a load carrier indirectly to the buffer location in the storage and retrieval level by transporting the load carrier to a transfer section in the warehouse level, from which the vertical conveyor takes over the load carrier.

If the load carrier is to be stored, it may be thought of the load carrier being temporarily stored in a further buffer location before being temporarily stored in the buffer location or before passing the buffer location if the buffer location is occupied by another load carrier.

The at least one further buffer location may be located between a pre-storage zone, from which the load carrier is conveyed to the rack structure, and the buffer location.

The buffer location may be occupied by another load carrier while the vertical conveyor is carrying out an order, which is why it cannot yet take over the load carrier waiting at the buffer location.

If the load carrier is to be retrieved, it may be thought of the load carrier being temporarily stored in a further buffer location before it is temporarily stored in the buffer location or before it passes the buffer location, if the buffer location is occupied by another load carrier.

The further buffer location can be between a location, where the shuttle delivers the load carrier, and the buffer location.

The buffer location may be occupied by another load carrier while the vertical conveyor is carrying out an order, which is why it cannot yet take over the load carrier waiting at the buffer location.

All embodiments of the methods described above can be carried out with all embodiments of the shuttle system described at the beginning.

In the context of embodiments of the method described above, the relocating of a load carrier, for example from a warehouse level to the storage and retrieval level or vice versa, can also be considered. Such a relocation comprises method steps of the storage and retrieval operations described above. For example, if a load carrier is to be relocated from a storage location in the warehouse level to a storage location in the storage and retrieval level, it is first transported from the vertical conveyor to the storage and retrieval level, as described with respect to retrieval, and transferred to the buffer location there. Then the steps described with regard to storing are performed at the storage and retrieval level. Relocating a load carrier from a storage location in the storage and retrieval level to a storage location in a warehouse level is carried out by first performing the steps described for retrieval. Once arrived at the buffer location, the vertical conveyor takes over the load carrier and transports it to the warehouse level, where the steps already described for storing are performed.

### BRIEF DESCRIPTION OF THE DRAWINGS

Further advantages, features and details of the invention result from the following description of preferred embodiments and from the drawings; these show in

FIGS. 1 to 3 three partial views of storage and retrieval levels 2 of various embodiments of a shuttle system according to the invention,

FIGS. 4 and 5 each show a sectional view of a storage warehouse level 3 of the embodiment according to FIG. 1 from different perspectives, and

FIG. 6 shows a transfer section 14.1.

### DETAILED DESCRIPTION

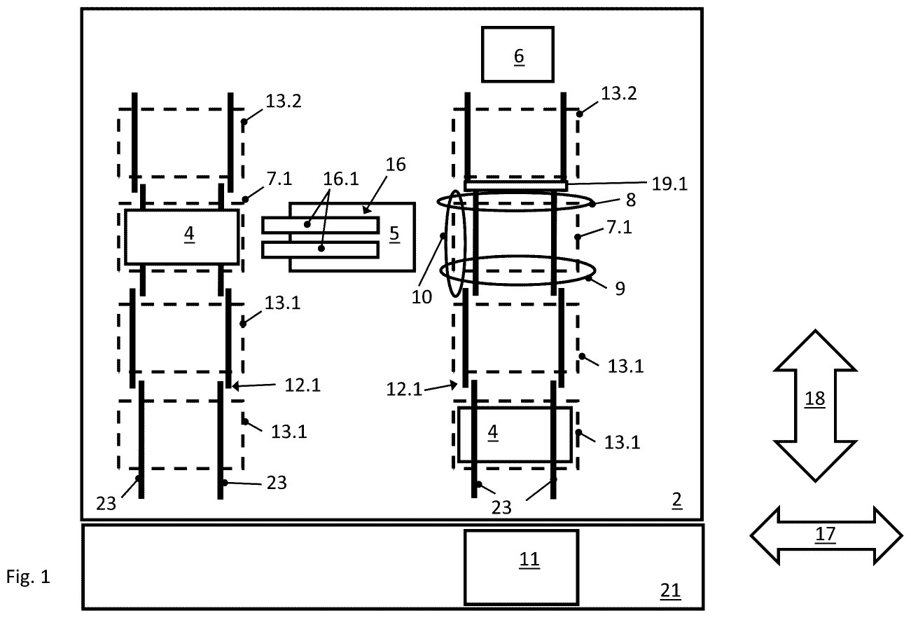

In FIG. 1, a first embodiment of a shuttle system according to the invention is partially shown. FIG. 1 schematically shows a section of a storage and retrieval level 2 of this embodiment as well as a section of a pre-storage zone 21. In FIG. 1 a load carrier 4, a vertical conveyor 5 with a telescopic fork 16 comprising two tines 16.1, a shuttle 6, two buffer locations 7.1 situated immediately adjacent to the vertical conveyor 5 with transfer sections 8, 9, 10, an AGV 11, a chain conveyor arrangement 12.1 comprising four two-track chain conveyors situated in series, each with two chains 23, several further buffer locations 13.1, 13.2, a direction 17 and an orthogonal direction 18 thereto, as well as a movable centering means 19.1 can be recognized. The chain conveyor arrangement 12.1 shown on the left in FIG. 1 serves for the retrieval, as will be described in more detail subsequently, and therefore does not include a centering means 19.1, in contrast to the chain conveyor arrangement 12.1 shown on the right.

The buffer location 7.1 shown on the left in FIG. 1, on which one of the two load carriers 4 shown in FIG. 1 is located, comprises the three transfer sections 8, 9, 10, as does the buffer location 7.1 shown on the right, but these are not shown on the left for the sake of clarity.

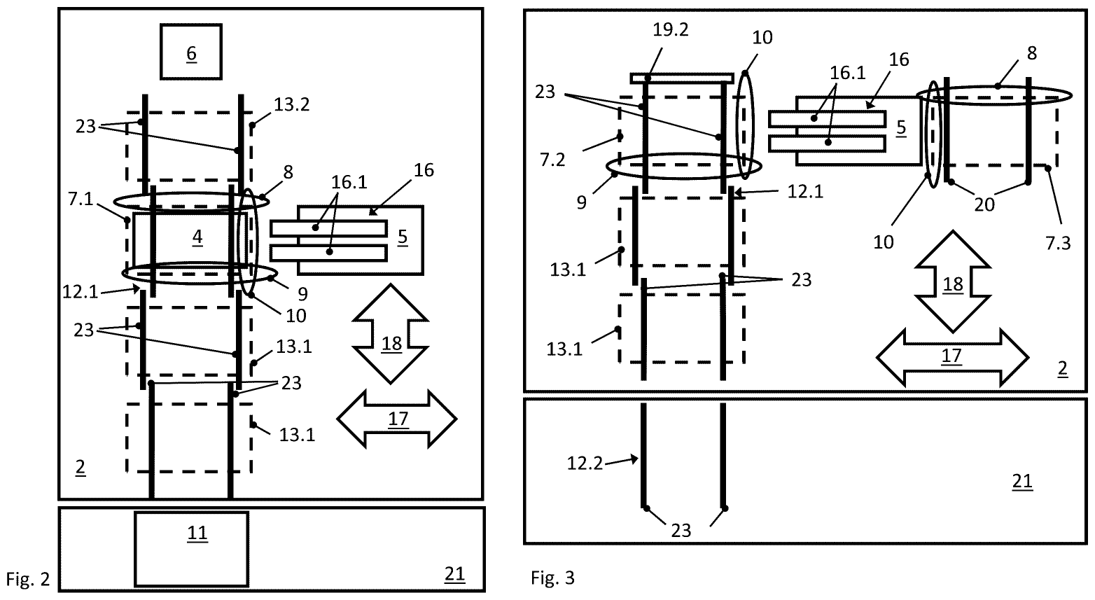

In FIG. 2, a second embodiment of a shuttle system according to the invention is partially shown. FIG. 2 schematically shows a section of a storage and retrieval level 2 of this embodiment as well as a section of a pre-storage zone 21. With regard to its structure, the arrangement according to FIG. 2 is essentially similar to the left side of FIG. 1. The buffer location 7.1 according to FIG. 2 is situated directly next to the vertical conveyor 5.

In FIG. 3, a third embodiment of a shuttle system according to the invention is partially shown. FIG. 3 schematically shows a section of a storage and retrieval level 2 of this embodiment as well as a section of a pre-storage zone 21. Compared to the embodiment shown in FIG. 2, the embodiment shown in FIG. 3 comprises a chain conveyor 12.2 in the pre-storage zone 21 instead of an AGV 11. Furthermore, the embodiment shown in FIG. 3 does not comprise another buffer location 13.2, which is adjacent to the transfer section 8 on the storage side. Although the buffer location 7.2 includes a pre-zone side transfer section 9 and a vertical conveyor side transfer section 10, it does not include a store side transfer section 8, but instead includes a centering means 19.2 in the form of a rigid stop. Situated next to the vertical conveyor 5 and opposite the buffer location 7.2 is an additional buffer location 7.3, which is formed from parking rails 20. This buffer location 7.3 comprises a transfer section 10 on the vertical conveyor side and a transfer section 8 on the storage side. The buffer locations 7.2, 7.3 are situated directly adjacent to the vertical conveyor 5.

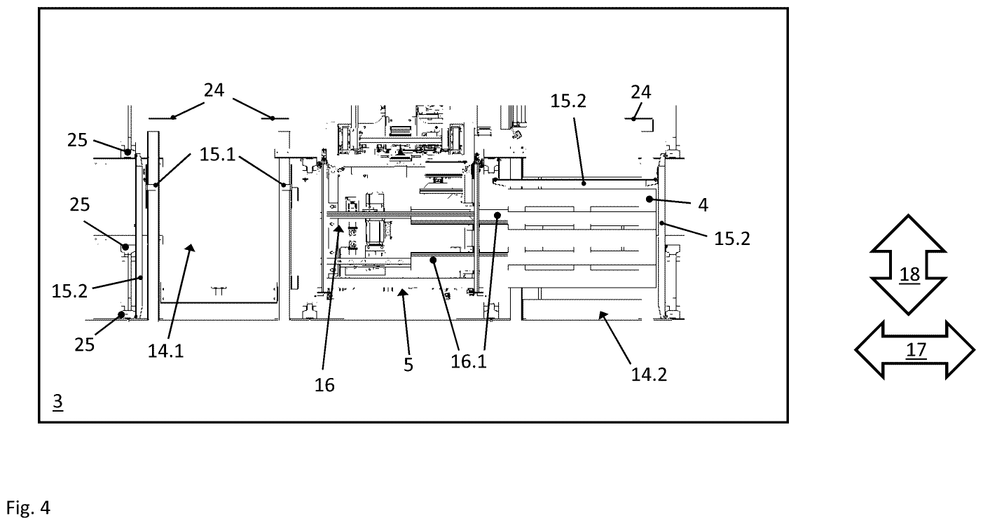

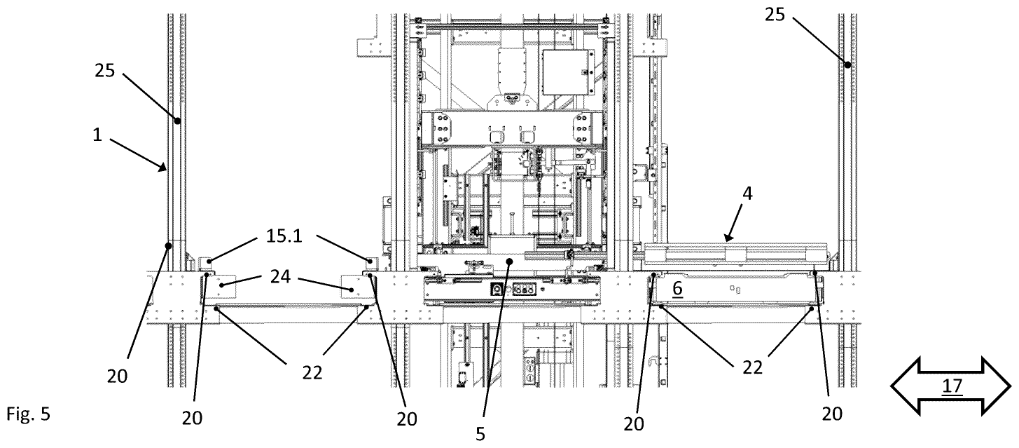

FIG. 4 shows a top view of a warehouse level 3 of the first embodiment of the shuttle system. The warehouse level 3 of FIG. 4 corresponds in this respect to the storage and retrieval level 2 according to FIG. 1. Two transfer sections 14.1, 14.2, the vertical conveyor 5 with telescopic fork 16 as well as centering means 15.1, 15.2 can be seen in the warehouse level 3. In FIG. 4, a rack structure 1 can further be seen, which comprises, among other things, rack uprights 25, parking rails 20 for the load carriers 4 and rails 22 for the shuttles 6. The centering means 15.1 may be simple stops. Furthermore, stoppers 24 for limiting an entry depth of the shuttle 6 into the transfer sections 14.1, 14.2 can be seen in the illustration according to FIG. 4, i.e. along the direction 18—in the drawing “upwards”.

FIG. 5 shows a side view of the arrangement according to FIG. 4.

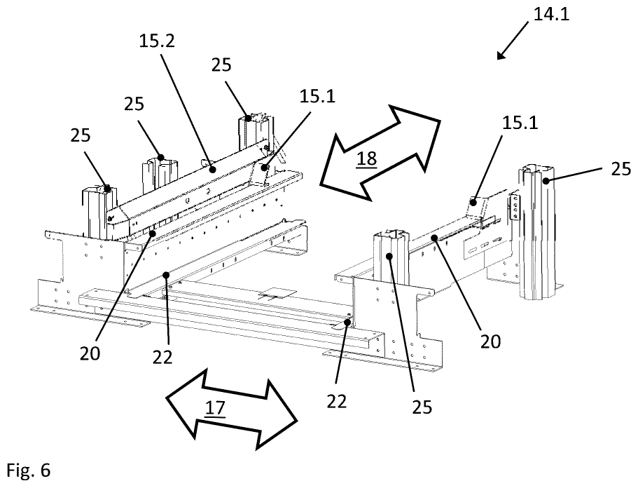

FIG. 6 shows the transfer section 14.1 according to FIG. 4, wherein, among other things, several rack uprights 25, i.e. parts of the rack structure 1, can be seen. The parking rails 20 and the rails 22 for the shuttle 6 (not shown) are visible. Furthermore, centering means 15 are recognizable: On the one hand, the transfer section 14.1 comprises a centering means 15.2 running parallel to the rails 20, 22. On the other hand, it comprises two narrow centering means 15.1 situated on the parking rails 20, which do not protrude beyond the parking rails 20. A clear width between the centering means 15.1 measured in direction 17 is therefore at least as large as the clear width between the parking rails 20 measured in direction 17.

With reference to the FIGS. 1 to 6, the operation of the device according to the invention is explained as follows:

With reference to FIGS. 1 to 3, a storing and retrieving is first explained below.

The chain conveyor arrangement 12.1 shown on the left in FIG. 1 is used for storing load carriers 4 from the storage and retrieval level 2 or from a higher or lower warehouse level 3. The chain conveyor arrangement 12.1 shown on the right in FIG. 1 is used for storing load carriers 4 coming from the pre-storage zone 21 and which are to be stored. Both chain conveyor arrangements 12.1 are served by the same vertical conveyor 5. The system shown in FIG. 1 therefore allows a double play in which empty runs of the vertical conveyor 5 are avoided or at least reduced because it is responsible for storage and retrieval. Furthermore, fewer vertical conveyors 5 are required if they perform double plays. After storing a load carrier 4 on a higher warehouse level 3, the vertical conveyor 5 can take over another load carrier 4 from this warehouse level 3 that is ready for retrieval and transport it to the storage and retrieval level 2. Storage and retrieval movements are therefore connected with each other if possible. If no load carrier 4 to be retrieved is available after the end of storage, the vertical conveyor 5 can also perform an empty run instead of waiting for a load carrier 4 to be retrieved for a longer time on the warehouse level 3.

Each buffer location 7.1, 13.1, 13.2 is hereby formed by exactly one of the four chain conveyors within the chain conveyor arrangement 12.1, wherein each chain conveyor in turn comprises two chains 23.

An AGV 11 traveling in the pre-storage zone 21 delivers the load carrier 4 and transfers it to the chain conveyor arrangement 12.1 shown on the right side of FIG. 1. This transfer is performed along the direction 18 and “upwards” in the illustration of FIG. 1. The right side of FIG. 1 shows the situation immediately after the transfer of the load carrier 4 from the AGV 11 to the chain conveyor arrangement 12.1, wherein the load carrier 4 is located in the first of a total of two further buffer locations 13.1.

If the load carrier 4 is supposed to be stored in the storage and retrieval level 2, it is transported by the chain conveyor arrangement 12.1 along the direction 18, which at the same time represents the longitudinal direction of the chain conveyor arrangement 12.1, to the waiting shuttle 6, which is shown in the upper right corner in FIG. 1. When the load carrier 4 reaches the buffer location 7.1 by entering it via the transfer section 9 on the pre-zone side, it is then pressed against the foldable centering means 19.1 by the chain conveyor arrangement 12.1 or more precisely by the chain conveyor which forms the buffer location 7.1 and is centered herein if necessary, wherein for example any twisting of the load carrier 4 is corrected. Afterwards the centering means 19.1 folds away and the load carrier 4 is transported to the further buffer location 13.2. It then leaves the buffer location 7.1 through the transfer section 8 on the storage side. The shuttle 6 then enters the chain conveyor which forms the further buffer location 13.2 (top right in FIG. 1) and takes over the previously centered load carrier 4 from the further buffer location 13.2.

If the shuttle 6 shown at the top right in FIG. 1 is not yet ready, the load carrier 4 can wait for the shuttle 6 at the additional buffer location 13.2. The chain conveyor arrangement 12.1 therefore decouples the actions and orders of the AGV 11 and the shuttle 6, which therefore do not have to be at the same place at the same time to transfer the load carrier 4.

In this context, it should be noted that the shown individual chain conveyors, which form the chain conveyor arrangement 12.1, preferably each have a separate actuator (not shown). The individual chain conveyors can therefore be driven independently of one another. If a load carrier 4 is waiting at the further buffer location 13.2, the chain conveyors, which form the upstream buffer location 7.1 and the further buffer locations 13.1 upstream of it in turn can still be operated and, for example, transport a load carrier 4 from the pre-storage zone 21 to the vertical conveyor 5.

If the load carrier 4 is to be stored in a warehouse level 3 (not shown in FIG. 1, but shown in FIG. 4, for example), which is located above the storage and retrieval level 2, for example, the load carrier 4 must be transported there by the vertical conveyor 5. After the transfer of the load carrier 4, shown on the right in FIG. 1, from the AGV 11 to the chain conveyor arrangement 12.1, the latter transports the load carrier 4 for this purpose to the buffer location 7.1. The centering at the centering means 19.1 ensures that the tines 16.1 of the telescopic fork 16 can take over the load carrier 4 correctly. If the load carrier 4 is a pallet, the centering ensures that the tines 16.1 can enter the pockets of the pallet. The tines 16.1 of the telescopic fork 16 of the vertical conveyor 5 thus take over the load carrier 4 and transport it to the vertical conveyor 5. If the load carrier 4 is on the vertical conveyor 5, it is transported vertically by the latter to a higher warehouse level 3.

The vertical conveyor 5 shown in FIG. 1 has just placed a load carrier 4 on the chain conveyor arrangement 12.1 shown on the left in FIG. 1 and would therefore not yet be ready to take over a load carrier 4 coming from the right. If there would be a load carrier 4 in the buffer location 7.1 on the chain conveyor arrangement 12.1 shown on the right in FIG. 1, the tines 16.1 of the telescopic fork 16 would have to extend to the right, starting from the position shown in FIG. 1, in order to take over this load carrier 4 from the buffer location 7.1 via the transfer section 10 on the vertical conveyor side. This pickup of the load carrier 4 or transfer of the load carrier 4 from the buffer location 7.1 to the vertical conveyor 5 is performed along a direction 17.

If the vertical conveyor 5 has not yet completely finished a preceding order, as shown in FIG. 1 and described in detail above, the load carrier 4 can wait for the vertical conveyor 5 at the buffer location 7.1. The buffer location 7.1 thus decouples the actions and orders of the AGV 11 from those of the vertical conveyor 5. For the transfer of the load carrier 4 from the AGV 11 to the vertical conveyor 5, they do not have to be at the same place at the same time. In particular, the AGV 11 and the vertical conveyor 5 do not have to be in or at the storage and retrieval level 2 at the same time.

The subsequent storing on the warehouse level 3 is described further below with reference to FIGS. 4 to 6.

While the chain conveyor arrangement 12.1 shown on the right in FIG. 1 is used exclusively for storage, the chain conveyor arrangement 12.1 shown on the left in FIG. 1 is used exclusively for retrieval. Because it can be assumed that the shuttle 6 can only successfully transport the load carrier 4 and convey it to the further buffer location 13.2 shown on the left in FIG. 1 if the load carrier 4 has been placed correctly, i.e. centered, on the shuttle 6, the chain conveyor arrangement 12.1 shown on the left in FIG. 1 does not necessarily require a centering means 19. Typically, both the conveyors 11, 12.2 situated in the pre-storage zone 21 and the chain conveyor arrangement 12.1 in the rack structure are more tolerant to misplacement of the load carrier 4 on their respective upper sides than the shuttle 6.

If a load carrier 4 coming from a warehouse level 3 (not shown in FIG. 1) is supposed to be retrieved, it is transported by the vertical conveyor 5 to the storage and retrieval level 2 and transferred via the transfer section 10 on the vertical conveyor side (not shown in FIG. 1 on the left for the sake of clarity) to the chain conveyor arrangement 12.1, specifically to the buffer location 7.1 shown on the left. This situation immediately after such a transfer of a load carrier 4 is shown in FIG. 1. The chain conveyor arrangement 12.1 then conveys the load carrier 4 along direction the 18 to the pre-storage zone 21. For this purpose, the load carrier 4 leaves the buffer location 7.1 shown on the left via the transfer section 9 on the pre-storage zone side (not shown on the left in FIG. 1 for the sake of clarity).

As the chain conveyor arrangement 12.1 transports the load carrier 4 directly towards the pre-storage zone 21, the load carrier 4 does not occupy the buffer location 7.1 and this is available for further load carriers 4. Even if an AGV 11, which is supposed to take over the load carrier 4, is not yet available, the additional buffer locations 13.1 ensure that no congestion situation occurs. The vertical conveyor 5 is thus decoupled during retrieval with regard to its actions and orders from any actions and orders of the AGV 11 which is supposed to take over the load carrier 4 to be retrieved.

If a load carrier 4 coming from the storage and retrieval level 2 is to be retrieved, it is transported by the shuttle 6 to the further buffer location 13.2 shown on the left in FIG. 1 in that the shuttle 6 moves into the chain conveyor arrangement 12.1 in order to be able to place the load carrier 4 on the further buffer location 13.2. After being set down, the load carrier 4 is placed on the chain conveyor arrangement 12.1. The load carrier 4 is then transferred to the buffer location 7.1 via the transfer section 8 on the storage side (not shown in FIG. 1 on the left for the sake of clarity). This transfer, i.e. the entry of the shuttle 6, is therefore performed along the direction 18, as is the subsequent transport of the load carrier 4 on the chain conveyor arrangement 12.1 to the pre-storage zone 21. The load carrier 4 is then transferred to the AGV 11 from the last further buffer location 13.1 before the pre-storage zone 21, which is shown at the bottom left in FIG. 1.

If the vertical conveyor 5 and the shuttle 6 each transfer a load carrier 4 to the chain conveyor arrangement 12.1 shown on the left in FIG. 1 at approximately the same time, congestion situations could occur in which the buffer capacity of the buffer locations 13.2, 13.1, 7.1 is advantageous: If, for example, a load carrier 4 transported by the vertical conveyor 5 to the storage and retrieval level 2 is temporally ahead of the load carrier 4 which is to be transferred by the shuttle 6 travelling in the storage and retrieval level 2 to an AGV 11 waiting in the pre-storage zone 21, the load carrier 4 delivered by the shuttle 6 can wait at the buffer location 13.2 until the vertical conveyor 5 places the load carrier 4 to be retrieved previously at the buffer location 7.1. The chain conveyor arrangement 12.1 then transports both load carriers 4 to the pre-storage zone 21, where they are transferred in the correct sequence to the corresponding AGV 11.

Furthermore, it may be the case that a load carrier 4 coming from a warehouse level 3 (not shown in FIG. 1) is to be transferred to the storage and retrieval level 2, for example in order to be able to retrieve this load carrier 4 at a later point in time without using the vertical conveyor 5. Until the load carrier 4 reaches the vertical conveyor 5, the transfer is similar to the retrieval described above. The vertical conveyor 5 then transfers the load carrier 4 to the buffer location 7.1 shown on the right in FIG. 2. From there, the load carrier 4 is stored in the storage and retrieval level 2 in the same way as described above for the storing.

FIG. 2 shows in extracts a shuttle system, in which the vertical conveyors 5 perform single plays. The section shown in FIG. 2 is used for the retrieval of load carriers 4. In addition, this system, which is only partially shown, preferably also comprises a similarly constructed, but not shown, arrangement in the storage and retrieval level 2, which comprises exactly one chain conveyor arrangement 12.1, a centering means 19.1 and exactly one vertical conveyor 5, but is used for storage.

In addition, the retrieval of a load carrier 4 in the variant shown in FIG. 2 proceeds as already described with reference to the left side of FIG. 1. The main difference is that the vertical conveyor 5 of FIG. 2 performs an empty run after transferring a load carrier 4 to the buffer location 7.1 in order to return to the warehouse level 3. The advantage of the variant shown in FIG. 2 is the greater robustness and the simple design. Furthermore, in the event of a fault or malfunction of the vertical conveyor 5, either the retrieval or the storage process is affected, but not both.

FIG. 3 shows a in extracts a shuttle system that differs more clearly from those shown in FIGS. 1 and 2. No AGV 11 operates in the pre-storage zone 21, instead, a chain conveyor 12.2 is situated there, which can transfer load carriers 4 to the chain conveyor arrangement 12.1 in the storage and retrieval level 2. Furthermore, the chain conveyor arrangement 12.1 comprises a rigid lock 19.2 as centering means. Shuttles 6 thus cannot enter the buffer location 7.2, which therefore does not comprise a transfer section 8 on the storage side. Situated opposite the buffer location 7.2 is a passive buffer location 7.3, which is formed by two parking rails 20. The aforementioned buffer locations 7.2, 7.3 permit in combination all the actions already described with respect to buffer locations 7.1 of FIGS. 1 and 2.

The arrangement shown in FIG. 3 is used for the storage of a load carrier 4. This load carrier 4 (not shown in FIG. 3) is transferred from the chain conveyor 12.2 in the pre-storage zone 21 to the chain conveyor arrangement 12.1 in the storage and retrieval level 2 along the direction 18. If a load carrier 4 to be stored is still waiting for the vertical conveyor 5 at the buffer location 7.2, the newly added load carrier 4 can wait at the further buffer location 13.1 until the buffer location 7.2 has become free. The chain conveyor arrangement 12.1 then transports the load carrier 4 to the buffer location 7.2, into which the load carrier enters via the pre-zone-side transfer section 9. The chain conveyor arrangement 12.1 hereby moves the load carrier 4 against the centering means 19.2 in order to center the load carrier 4, if necessary, so that the tines 16.1 of the telescopic fork 16 can take it over. The telescopic fork 16 takes over the load carrier 4 via the vertical conveyor-side transfer section 10 of the buffer location 7.2.

If the load carrier 4 is to be stored in the storage and retrieval level 2, the telescopic fork 16 transfers the load carrier directly to the opposite buffer location 7.3. This movement is performed along the direction 17. After the load carrier 4 has been placed on the parking rails 20 of the buffer location 7.3, a shuttle 6 can enter the buffer location 7.3 via the transfer section 8 on the storage side along the direction 18 in order to take over the load carrier 4.

If the load carrier 4 is to be stored in a warehouse level 3, the vertical conveyor 5 takes over the load carrier 4 with the help of the telescopic fork 16 and then moves to the desired warehouse level 3.

As already described with regard to FIG. 2, the vertical conveyor 5 also performs single plays as shown in FIG. 3.

The buffer locations 7.2, 7.3 assigned to the vertical conveyor 5 in FIG. 3 enable, thanks to the transfer sections 8, 9 10 and the centering means 19.2, all actions which are also enabled by the buffer locations 7.1 of FIGS. 1 and 2. The arrangement according to FIG. 3 comprises, so to speak, a “split” buffer location, which consists of the two aforementioned buffer locations 7.2, 7.3.

In a broader sense, all arrangements according to FIGS. 1 to 3 each represent a three-way intersection, which allows the takeover and handover of a load carrier 4 between a conveyor 11, 12.2 in the pre-storage zone 21, a shuttle 6 in the storage and retrieval level 2 and a shuttle 6 in a warehouse level 3. In this case, takeover and handover to and from the shuttle 6 in the warehouse level 3 is performed with the aid of the intermediate vertical conveyor 5, which takes over the vertical transport of the load carrier 4.

FIGS. 4 and 5 show the retrieval and storage of load carriers 4 on one of the warehouse levels 3. The warehouse level 3 shown in FIG. 4 is part of a shuttle system whose retrieval and storage level 2 is shown in FIG. 1.

To retrieve a load carrier 4 stored on the warehouse level 3, it is conveyed by a shuttle 6 along the direction 18, i.e. in FIG. 4 thus coming from below, to the transfer section 14.2 shown on the right in FIG. 4 and set down there. The shuttle 6 moves on the rails 22 into the transfer section 14.2. Because it can be assumed for the reasons already explained that the load carrier 4 is correctly positioned, i.e. centered, on the shuttle 6, the centering means 15.2 of the transfer section 14.2 are not absolutely necessary, but can nevertheless be advantageous. These centering means 15.2 compensate, for example, positioning tolerances of the shuttle 6. The elongated centering means 15.2 running along the direction 18 can at least partially center the position of a load carrier 4 standing twisted on the shuttle 6 as well as a load carrier 4 shifted to the right along the direction 17 (in FIG. 4). The centering means 15.2 running along the direction 17 may serve as a stop, wherein the shuttle 6 presses the load carrier 4 along the direction 18 against this centering means 15.2 running along the direction 17. In this case, at least partial centering of the load carrier 4 on the shuttle 6 can also be performed, for example, the load carrier 4 can be shifted along the direction 18—in FIG. 4 “downward”—on the shuttle 6. The shuttle 6 places the load carrier 4 on the parking rails 20 and then leaves the transfer section 14.2 again. This situation is shown on the right in FIG. 5. The centering ensures that the tines 16.1 of the telescopic fork 16 can correctly take over the load carrier 4. Once the load carrier 4 is on the vertical conveyor 5, the latter transports the load carrier 4 to the storage and retrieval level 2, where it is retrieved, which has already been described with reference to FIG. 1.

For storing a load carrier 4 to be stored in the warehouse level 3, it is taken over by the vertical conveyor 5 in the storage and retrieval level 2 and transported to the warehouse level 3, as already described with reference to FIG. 1. The telescopic fork 16 of the vertical conveyor 5 shown in FIGS. 4 and 5 then transfers the load carrier 4 along the direction 17, to the left in FIGS. 4 and 5, to the transfer section 14.1 shown there. This comprises the narrow centering means 15.1 and the elongated centering means 15.2, which ensure that the load carrier 4 is correctly centered on the parking rails 20 before being taken over by the shuttle 6 and can thus also be taken over correctly centered by the shuttle 6.

The shuttle 6 (not shown in FIG. 4) then enters the transfer section 14.1 shown on the left along the direction 18 and in the illustration according to FIG. 4 “from below”, in order to take over the load carrier 4. The shuttle 6 then stores the load carrier 4 in the warehouse level 3.

FIG. 6 shows how transfer and centering of the load carrier 4 can be performed at the transfer section 14.1 shown on the left in FIG. 4:

The tines 16.1 of the telescopic fork 16 transfer a load carrier 4, which has been transported by the vertical conveyor 5 to the warehouse level 3, to the transfer section 14.1. In this case, the tines 16.1 of the telescopic fork 16 are lowered in a known manner, i.e. moved vertically downwards a short distance until the load carrier 4 stands on the parking rails 20 and the tines 16.1 can be retracted to the right in FIG. 4. During this lowering of the telescopic fork 16, the load carrier 4, if it was not centered, i.e. not correctly positioned on the telescopic fork 16, slides along the centering means 15.1, 15.2, whereby it is centered.

Additionally or alternatively, centering can be performed not only during lowering of the telescopic fork 16, but also already during movement in direction 17, namely when the telescopic fork 16 presses the non-centered load carrier 4 against the centering means 15.2, thus eliminating any incorrect positioning, such as twisting of the load carrier 4 or incorrect positioning in the sense of a load carrier 4 placed “too far to the left” (in FIG. 4) on the telescopic fork 16.

In addition or alternatively, centering can be performed in particular at the centering means 15.1 with the aid of the shuttle 6 (not shown in FIG. 6). For this purpose, the shuttle 6 can drive under the load carrier 4, which is not correctly positioned on the parking rails 20 of the transfer section 14.1, and lift it with the aid of its known load-carrying means, i.e., for example, a lifting device. If the shuttle 6 then travels a short distance along the direction 18, it can position the load carrier 4 relative to the centering means 15.1 in such a way that it slides along the centering means 15.1 and is centered when it is lowered by the load-carrying means of the shuttle 6. This centering effected by the shuttle 6 can be performed in a sensor-controlled manner, for example sensors present in the shuttle 6 can be used as on-board equipment. It is also possible that the shuttle 6 performs the process described above several times in a row, and hereby moves a short distance along direction 18 towards or away from the centering means 15.1 after each lifting of the load carrier 4. This can ensure that during the sequence described above, the load carrier 4 is positioned at least once relative to the centering means 15.1 in such a way that successful centering can be performed.

In this case, it is advantageous that the clear width between the centering means 15.1 is at least as large as the clear width between the parking rails 20 measured in direction 17.

If the centering means 15.1 were formed continuously along the direction 17, i.e. similar to the elongated centering means 15.2 with respect to the direction 18, or if the centering means 15.1 were to protrude at least far into an intermediate space between the parking rails 20, the shuttle 6 with lifted the load carrier 4 and thus extended load-carrying means would not be able to travel as far as desired along the direction 18 towards the centering means 15.1. In the case of a centering means 15.1 that is formed continuously or protrudes into the intermediate space, the load-carrying means of the shuttle 6 would otherwise collide with the centering means 15.1, so that a retraction width along the direction 18 would be limited by this impending collision. Depending on the dimensions of the load carrier 4, it could then be the case that a centering at the centering means 15.1 by lowering the load-carrying means would not be possible because the shuttle 6 cannot enter the transfer section 14.1 far enough because of the impending collision. If, after reaching the maximum entry width, which is determined by the impending collision described above, the load carrier 4 and the centering means 15.1 protruding at least into the intermediate space are oriented towards each other in such a way that, when the load-carrying means is lowered, a sliding along the centering means 15.1 is not possible, because the shuttle 6 cannot enter the transfer section 14.1 far enough, so to speak, a centering is not possible.

The arrangement of the two narrow centering means 15.1 on the parking rails 20 shown in FIG. 6 ensures that the problem described above does not occur.

Although only some preferred embodiments of the invention have been described and illustrated, it is apparent that the skilled person can add numerous modifications without departing from the essence and scope of the invention. In particular, the modifications described subsequently may be thought of. The reference numerals of the modifications refer to the reference numerals of FIGS. 1 to 6, wherein the modifications described below are mostly not shown in the figures.

The rack structure 1 is only implied in FIGS. 4 to 6. Of course, all embodiments of the shuttle system with rack levels 2, 3 include a rack structure 1 which, among other things, forms these rack levels 2, 3.

The storage and retrieval level 2 is preferably the lowest level of the rack structure 1, and warehouse levels 3 are preferably located above it. Usually, there are several warehouse levels 3 but only one single storage and retrieval level 2. In rare embodiments, shuttle systems with multiple storage and retrieval levels 2 may be thought of. It may also be considered that a further warehouse level 3 is also situated below the storage and retrieval level 2, usually as below the ground or bottom level.

Both the pre-storage zone 21 and the storage and retrieval level 2 are usually significantly larger than shown in the figures. A large number of AGVs 11 and/or a large number of chain conveyors 12.2 can travel or be situated in the pre-storage zone 21. The same applies to the shuttles 6 in the storage and retrieval level 2 and in the warehouse levels 3, but also to the chain conveyor arrangements 12.1 and the vertical conveyors 5.

The shuttles 6 can usually move horizontally, i.e. in the direction 18 and in the direction 17. However, it is also possible to have shuttles 6 that can move exclusively in the direction 18, for example.

Since the shuttles 6 usually cannot change the rack levels 2, 3, there is at least one shuttle 6 on each level 2, 3. Alternatives are conceivable.

The vertical conveyors 5 can connect all rack levels 2, 3 of the shuttle system. Alternatively, it is also possible to use several vertical conveyors 5, wherein each vertical conveyor 5 serves or connects only some of the rack levels 2, 3, preferably always including the storage and retrieval level 2.

Preferably, the transfer sections 8, 9, 10 do not exist as physically delimited units, but only designate sections within the buffer locations 7.1, 7.2, 7.3, wherein the transfer of the load carrier 4 to or from of the buffer location 7.1, 7.2, 7.3 takes place through or along the transfer sections 8, 9, 10.

As explained with reference to FIGS. 1 and 2, the transfer of the load carrier 4 from the shuttle 6 to the buffer location 7.1 is performed via the further buffer location 13.2, i.e. indirectly. It is also possible to think of embodiments which do not have a further buffer location 13.2. In such an embodiment, the shuttle 6 can enter the buffer location 7.1 directly via the transfer section 8 on the storage side in order to transfer the load carrier 4 to the buffer location 7.1 or to place it there. The same applies to the transfer of a load carrier 4 by the shuttle 6 from the buffer location 7.1 in the reverse direction, so if there are no further buffer locations 13.1.

The conveyors shown in the pre-storage zone 21, i.e. the chain conveyor 12.2 and the AGV 11, can be located essentially outside the rack structure 1 and therefore outside the storage and retrieval level 2 formed by this rack structure 1. Here, “essentially” means that, for example, it can also be thought of that the AGV 11 moves a little way into the storage and retrieval level 2 or that the chain conveyor 12.2 is built in such a way that a section of this chain conveyor 12.2 protrudes into the storage and retrieval level 2. Such a chain conveyor 12.2 can also be located entirely within the rack structure 1, for example within the storage and retrieval level 2. In this case, it can be considered that the chain conveyor 12.2 acts as an interface together with another conveyor.

It may also be thought of that the chain conveyor 12.2 or an alternative continuous conveyor is not completely or substantially, but only at least partially located outside the rack structure 1. The chain conveyor 12.2 or the alternative continuous conveyor can thus be located to a large extent inside the rack structure 1, for example sections of the rack structure 1 can surround the chain conveyor 12.2 in order to create as much storage location as possible. A chain conveyor 12.2 or the like located only partially outside the rack structure 1 can also act as an interface to the pre-storage zone 21.

Alternatively to the AGV 11 and the chain conveyor 12.2, other conveyors may be envisaged. The chain conveyor 12.2 and the AGV 11 in the pre-storage zone 21 can be alternative in all embodiments. Other continuous conveyors may be used as an alternative to a chain conveyor 12.2. There may also be thought of pre-storage zones 21 comprising both AGV 11 and chain conveyor 12.2 and/or other alternative conveyors.

As an alternative to the situation shown in FIGS. 1 to 3, it may be considered that the conveyor 11, 12.2 transfers the load carrier 4 directly to the buffer location 7.1, 7.2. In such an embodiment, the further buffer locations 13.1 between the conveyor 11, 12.2 and the buffer location 7.1, 7.2 can therefore be dispensed with, as already indicated above. Instead of the indirect transfer of the load carrier 4 from the conveyor 11, 12.2 to the buffer location 7.1 via the intermediate further buffer locations 13.1 shown in the Figures, a direct transfer of the load carrier 4 can also be considered. Analogous considerations apply to the retrieval of a load carrier 4, i.e. to its transfer from the buffer location 7.1 to the conveyor 11, 12.2.

Instead of the telescopic fork 16, alternative means may be thought of which can actively take over the load carrier 4 from the buffer location 7.1, 7.2, 7.3 and transfer it to the latter. For example, a corner transfer unit may be thought of which comprises, for example, two belts, chains or the like running in parallel in order to move the load carrier 4 orthogonally to a longitudinal direction of the chain conveyor 12.1 running in the direction 18, i.e. along or parallel to the direction 17. The vertical conveyor 5 may comprise such an alternative means, but it may also only be assigned thereto, but not, for example, integrated into the vertical conveyor 5. In particular, such an alternative means can be a corner transfer unit, which is located on or forms the buffer location.

Usually, the further buffer locations 13.1 between the vertical conveyor 5 or the buffer location 7.1, 7.2 and the pre-storage location 21 are more important than the further buffer locations 13.2 above the buffer location 7.1, 7.2. The reason for this is that the shuttle system usually comprises only one storage and retrieval level 2 with a limited number of storage locations, but considerably more warehouse levels 3 with considerably more storage locations. The majority of the load carriers 4 to be stored are therefore transferred to the warehouse levels 3 via the vertical conveyor 5: accordingly, the majority of the load carriers 4 to be retrieved are conveyed from the warehouse levels 3 and not from the storage locations of the storage and retrieval level 2 to the buffer location 7.1, 7.2. Therefore, the further buffer locations 13.1 are usually needed more frequently as the further buffer location 13.2 For the same reason, it is usually sufficient to provide a single further buffer location 13.2, whereas, as shown, two further buffer locations 13.1 are provided. However, it may also be considered to provide more than two further buffer locations 13.1 for the reasons mentioned.

Although it may also be possible to provide more than two additional buffer locations 13.2, this is only likely to be useful if there are either a large number of storage locations in a storage and retrieval level 2 or if retrieval and storage operations of load carriers 4 to or from a storage and retrieval level 2 are performed very frequently. Furthermore, two or more additional buffer locations 13.2 can be useful if only a few shuttles 6 are in use in the storage and retrieval level 2 or if the travel distances between the additional buffer locations 13.2 in the storage and retrieval level 2 and the storage locations located in this level are very long, so that several additional load carriers 4 are already available for storing in the storage and retrieval level 2 before the shuttle 6 returns to the additional storage location 13.2.

As an alternative to the chain conveyor arrangement 12.1 situated in the storage and retrieval level 2, a roller conveyor or other continuous conveyor may be considered.

The chain conveyor arrangement 12.1 and the chain conveyor 12.2 in FIG. 3 can be placed directly adjacent to each other in order to be able to convey a load carrier 4 seamlessly from the pre-storage zone 21 into and out of the storage and retrieval level 2.

The shuttle system shown only partially in FIG. 3 can also include an arrangement analogous to that shown in FIG. 3, but for retrieval. Alternatively, it may be considered that the arrangement shown in FIG. 3 serves for storage and retrieval, but this is less preferred.

Both the shuttles 6 and the AGVs 11 preferably comprise load-carrying means not shown in detail, for example a lifting device, which can raise and lower the load carrier 4, for example a pallet, on the upper side of the shuttle 6 and the AGV 11. This has already been described in more detail with regard to the centering and with reference to FIG. 6.

All embodiments of the shuttle system can comprise several vertical conveyors 5 in series, i.e. immediately adjacent to each other. Based on FIG. 1, it could be considered, for example, to place an additional vertical conveyor 5 directly next to the vertical conveyor 5 shown. This additional vertical conveyor 5 could, for example, be offset from the vertical conveyor 5 shown in direction 18 “upwards” in FIG. 1. Accordingly, two buffer locations 7.1 can be intended on each of the two chain conveyor arrangements 12.1, which are situated directly adjacent to the two vertical conveyors 5. These additional buffer locations 7.1, which, like the buffer locations 7.1 shown in FIG. 1, function as transfer sections for the vertical conveyors 5 in the storage and retrieval level 2, can be situated between the buffer location 7.1 shown in FIG. 1 and the further buffer location 13.2. Those buffer locations 7.1 situated one behind the other, which are formed by the chain conveyor arrangement 12.1 responsible for the storage, can each comprise a foldable centering means 19.1. Preferably, at least the buffer location 7.1 closest to the pre-storage zone 21 comprises such a foldable centering means 19.1.

The further buffer location 13.2 in FIG. 1, top right, can include further centering means to center the load carrier 4 very precisely before it is transferred to the shuttle 6. Centering means running parallel to the chains 23 may also be considered herein.

Although the storage level 3 according to FIG. 4 has only been described in relation to the embodiment of the storage and retrieval level 2 according to FIG. 1, the shuttle systems shown in detail in FIGS. 2 and 3 naturally also comprise warehouse levels 3. Regardless of whether the vertical conveyors 5 perform single or double plays, it may be considered to use warehouse levels 3 in the shuttle systems according to FIGS. 2 and 3, each with two transfer sections 14 as shown in FIGS. 4 and 5. The vertical conveyor 5 according to FIG. 2, which is responsible for retrieval in single play operation, can for example be assigned two transfer sections 14.2 in each of the warehouse levels 3, which are designed like the transfer section 14.2 shown on the right in FIG. 4. The vertical conveyor 5 according to FIG. 3, which is responsible for storing in single play operation, can for example be assigned two transfer sections 14.1 in each of the warehouse levels 3, which are designed like the transfer section 14.1 shown on the left in FIG. 4, which comprises three centering means 15.1, 15.2.

An advantage of shuttle systems in which vertical conveyors 5 are used in single-play operation, wherein two transfer sections 14.1 are provided next to the vertical conveyor 5 in each of the warehouse levels 3, is that a load carrier 4 placed on one of the transfer sections 14.1 can wait for a shuttle 6 if necessary, for example if the latter is delayed due to a malfunction. However, such a delay caused by a malfunction does not lead to a congestion if another load carrier 4 is supposed to be stored on the same warehouse level 3 because the vertical conveyor 5 can park it on the second transfer section 14.1 on the warehouse level 3. The same applies to two transfer sections 14.2 on the warehouse levels 3 next to the vertical conveyor 5, on which shuttles 6 can place two load carriers 4 to be retrieved next to the responsible vertical conveyor 5. This can be relevant, for example, if the shuttles 6 deliver the load carriers 4 to be retrieved faster than they can be transported by the vertical conveyor 5 to the storage and retrieval level 2.

Alternatively, for vertical conveyors 5, which are used in single play operation, only a single transfer section 14 can be intended in each of the warehouse levels 3.

Typically, the telescopic fork 16 can move along the direction 17 to convey a load carrier 4. Further, the telescopic fork 16 can typically move vertically to take over and set down a load carrier 4. This vertical movement may be performed by a vertical movement of the vertical conveyor 5 or by a vertical movement of the telescopic fork relative to the vertical conveyor 5.

The further buffer locations 13.2 can, as already indicated above, comprise centering means 15.2 on one or both sides running essentially parallel to the two-track chain conveyors of the chain conveyor arrangement 12.1, which are similar to the centering means 15.2 according to FIG. 6. Preferably, a distance between these centering means 15.2 of the further buffer locations 13.2, therefore their clear width measured in direction 17, can decrease “upwards” in FIG. 1. In this case, the centering means 15.2 do not run completely parallel to the chains 23. As a result, a load carrier 4 placed, for example, in a twisted position on the two-track chain conveyor arrangement 12.1 or a load carrier 4 placed too far to the left or right along the direction 17 on the chain conveyor arrangement 12.1 can be centered during the entry into the buffer location 13.2 by sliding along the centering means 15.2, which become increasingly narrower.

The buffer location 7.3 in the storage and retrieval level 2 can be designed as described for the transfer section 14.1 with regard to FIG. 6, in particular the centering means 15.1, 15.2 can be present. In both cases, this can serve to center the load carrier 4 before it is taken over by the shuttle 6, which is sensitive with regard to incorrect positioning. In addition or alternatively, the shuttle 6 can also center the load carrier 4 by lifting and setting it down several times, as already described above with regard to FIG. 6.

If a load carrier 4 is supposed to be transferred from, for example, the AGV 11 via the chain conveyor arrangement 12.1 to the shuttle 6 in the storage and retrieval level 2, and if this chain conveyor arrangement 12.1 does not include another buffer location 13.2, the load carrier 4 can, if necessary, also wait for the shuttle 6 at the buffer location 7.1.

Between the pre-storage zone 21 and the storage and retrieval level 2, there may be an entry and exit section of the shuttle system or of the rack structure 1 that is not shown separately in the figures. Facilities and arrangements serving the handover and takeover of load carriers 4 can be used herein. However, as has been described with reference to FIGS. 1 to 3, it may also be considered that a transfer of a load carrier 4 from a chain conveyor 12.2 or an AGV 11 to a chain conveyor arrangement 12.1 does not require any special devices.

All driveways in levels 2, 3 of the rack structure 1 may include the parking rails 20 and, in particular, the rails 22.

The surfaces of the centering means 15.1, 15.2 in FIG. 6 slope inclinedly towards the center of the transfer section 14.1. Alternative designs of these surfaces are conceivable.

A separate actuator (not shown) is preferably assigned in each case to the two-track chain conveyors, which are formed by the chains 23 and are only partially provided with reference numbers in FIGS. 1 to 3. In this way, for example, within a single chain conveyor arrangement 12.1, a first load carrier 4 located there can be moved by one of the chain conveyors, while a second load carrier 4 located there waits at the transfer section 7.1 or at the further transfer section 13.2, for example, for the vertical conveyor 5 or the shuttle 6. Forming each buffer location 13.2, 7.1, 7.2, 13.1 by a separate chain conveyor (as shown in FIGS. 1 to 3) with a separate actuator (not shown) allows great flexibility.

Alternatively, it may be thought of that a single chain conveyor within the chain conveyor arrangement forms several buffer locations 13.1, 7.1, 13.2, 7.2, or that at least two chain conveyors share one actuator. For example, it may be thought of coupling the two further buffer locations 13.1 to each other in one of the ways described above, so that load carriers 4 located there can only be moved synchronously and simultaneously. It may also be thought of the entire chain conveyor arrangement 12.1 being formed by a single chain conveyor.

The chain conveyor 12.2 in the pre-storage zone 21 can also be a chain conveyor arrangement and the details described with regard to the chain conveyor arrangement 12.1 thus apply analogously to the chain conveyor 12.2.

If, in the embodiment shown in FIG. 1, a load carrier 4 is transferred from the warehouse level 3 to the storage and retrieval level 2, the vertical conveyor 5 coming from the warehouse level 3 can alternatively transfer the load carrier 4 to the buffer location 7.1 shown on the left in FIG. 1, from which a storing can also be performed in the storage and retrieval level 2. However, it must be ensured that at the same time no load carrier 4 coming from the storage and retrieval level 2 is supposed to be retrieved via the further buffer location 13.2 shown at the top left of FIG. 1, because otherwise a blockage situation will occur. Preferably, the chain conveyors of the chain conveyor arrangement 12.1 shown on the left in FIG. 1 convey therefore only towards the pre-storage zone 21, i.e. in FIG. 1 downwards, while the chain conveyors of the chain conveyor arrangement 12.1 shown on the right in FIG. 1 convey only away from the pre-storage zone 21, in the illustration according to FIG. 1 thus upwards towards the shuttle 6.

The centering means 19.1 can be foldable, or alternatively pivotable, retractable or otherwise movable from a first to a second position. In a first position, the centering means 19.1 herein serves as a stop and allows the load carrier 4 to be centered. In a second position, the centering means 19.1 allows the load carrier 4 to pass through the transfer section 8 on the storage side.

All embodiments of the present invention can be equipped with such movable centering means 19.1.

In general, it may be thought of that the chain conveyor arrangement 12.1 comprises or consists of one or more chain conveyors. Preferably, these chain conveyors comprise exactly two chains 23, but chain conveyors comprising more than two chains 23 may also be contemplated.

Instead of the pre-storage zone 21 in FIGS. 1 to 3, another zone located outside the rack levels 2, 3 can also be thought of, wherein the AGV 11, the chain conveyor 12.2 or an alternative conveyor serve as an interface for the connection of this zone to the storage and retrieval level 2. This zone can also be situated below the rack levels 2, 3.

Based on FIG. 3, it may be considered that the storage and retrieval level 2 laterally surrounds the chain conveyor 12.2 at least in sections. It can also be envisaged that the warehouse level 3 partially or completely covers the chain conveyor 12.2.

1. A shuttle system, comprising:
a rack structure with a storage and retrieval level and at least one warehouse level for storing load carriers,
a vertical conveyor for transporting load carriers between the levels of the rack structure,
at least one shuttle arranged to travel in the levels of the rack structure,
at least one buffer location, which is situated in the storage and retrieval level directly next to the vertical conveyor, the at least one buffer location is set up to temporarily receive a load carrier, and the at least one buffer location comprises a transfer section on a storage side, on a pre-zone side, and on a vertical conveyor side for receiving and delivering the load carrier,
wherein the at least one shuttle is further set up to transfer a load carrier to be retrieved to the buffer location and to take over a load carrier to be stored from the buffer location, wherein this takeover and handover is performed via the transfer section on the storage side,
wherein the buffer location is further set up to take over or hand over a load carrier also from or to a conveyor acting as an interface between the storage and retrieval level and a zone located outside the rack levels, wherein the takeover and handover is performed via the transfer section on the pre-zone side,
wherein the vertical conveyor is operable to transfer the load carrier from the buffer location to the vertical conveyor or take the load carrier over from the vertical conveyor, wherein the takeover and transfer is performed via the transfer section on the vertical conveyor side,
wherein a direction along which the buffer location transfers the load carrier to or takes the load carrier over from the conveyor acting as an interface runs parallel to a direction along which the at least one shuttle transfers the load carrier to or takes the load carrier over from the buffer location, and
wherein a direction along which the vertical conveyor transfers the load carrier to or takes the load carrier over from the buffer location runs orthogonally to the direction along which the conveyor acting as an interface transfers the load carrier to or takes the load carrier over from the buffer location.

2. The shuttle system according to claim 1, wherein at least one further buffer location between the pre-zone-side transfer section and the conveyor acting as the interface.

3. The shuttle system according to claim 1, wherein the vertical conveyor includes a fork operable to actively transport the load carrier from the buffer location to the vertical conveyor and back.

4. The shuttle system according to claim 1, wherein two directly adjacent buffer locations are assigned to the vertical conveyor.

5. The shuttle system according to claim 1, wherein at least one further buffer location adjoins the transfer section on the storage side.

6. The shuttle system according to claim 1, wherein the buffer locations are formed by a continuous conveyor.

7. The shuttle system according to claim 1, wherein at least one centering means is arranged to center a load carrier after it has been delivered by the conveyor acting as an interface and before it has been taken over by the at least one shuttle or by the vertical conveyor.

8. The shuttle system according to claim 1, wherein at least one transfer section is arranged to temporarily take over a load carrier, and the transfer section further comprises at least one centering means, which is arranged to center a load carrier when the load carrier is set down on the transfer section by the at least one shuttle or the vertical conveyor.

9. The shuttle system according to claim 8, wherein the transfer section comprises two parking rails for parking the load carrier, wherein a centering means is situated on each of the two parking rails, and wherein a clear width between the centering means corresponds at least to the clear width between the two parking rails.

10. A method for handling a load carrier, wherein a storing or retrieving of the load carrier is performed in or from a rack structure, the method comprising:
temporarily storing the load carrier on a buffer location, which at the same time serves as a transfer section to a vertical conveyor, or passing this buffer location to store the load carrier in a storage and retrieval level or retrieve the load carrier from the storage and retrieval level.

11. The method according to claim 10, wherein a storing of the load carrier is performed in the rack structure, wherein:
a conveyor conveys the load carrier to the storage and retrieval level, where the load carrier is conveyed to the buffer location,
if the load carrier is supposed to be stored in the storage and retrieval level, the load carrier passes the buffer location and is taken over by a shuttle running in the storage and retrieval level, and
if the load carrier is supposed to be stored in a warehouse level, the load carrier is taken over at the buffer location by the vertical conveyor and transported to the warehouse level.

12. The method according to claim 10, wherein a retrieval of the load carrier from the rack structure is performed, wherein:
the shuttle or the vertical conveyor conveys the load carrier to the buffer location, and
a conveyor takes over the load carrier.

13. The method according to claim 10, wherein the load carrier is temporarily stored on a further buffer location before being temporarily stored on the buffer location or passing the buffer location if the buffer location is occupied by another load carrier.

14. The method according to claim 10, wherein the load carrier is temporarily stored on a further buffer location before being temporarily stored on the buffer location or passing the buffer location if the buffer location is occupied by another load carrier.

15. The method according to claim 10, which is performed with a shuttle system according to claim 1.

16. The shuttle system according to claim 3, wherein the fork comprises two tines.

17. The shuttle system according to claim 16, wherein the fork comprises a telescopic fork.

18. The shuttle system according to claim 17, wherein the telescopic fork comprises two tines.
